(19) United States
(12) Patent Application Publication
(10) Pub. No.: US 2009/0217943 A1
(43) Pub. Date: Sep. 3, 2009

(54) In-line stripping apparatus and method therefor

(76) Inventors: Ralph Raber, Evansville, IN (US); Hank Evans, Clinton, IA (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 11/629,008

(22) PCT Filed: Jun. 8, 2005
(86) PCT No.: PCT/US05/20238

§ 371 Date: Dec. 8, 2006

Related U.S. Application Data
(60) Provisional application No. 60/577,768, filed on Jun. 8, 2004.

(51) Int. Cl. B08B 1/02; B08B 3/00

(52) U.S. Cl. 134/3

(57) ABSTRACT

A method for stripping paint hangers in a paint conveyor system. The system comprising a plurality of operation stages for operating on articles coupled to the paint hangers, and with the paint hangers supported from at least one conveyor line. The method comprising: Performing operations on articles at operation stages, while paint hangers are supported from the conveyor line, removing the articles from the paint hangers following completion of performing of operations on the articles, performing in-line stripping process on the hangers, and returning stripped paint hangers to an initial one of the operation stages following the stripping process.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFISHE APPENDIX

Not applicable.

### BACKGROUND OF THE INVENTION

1. Field of the Invention

The invention relates to apparatus and methods for stripping paint hangers in a paint conveyor system and, more particularly, apparatus and methods associated with automating the stripping process.

2. Background Art

It is well known to employ conveyor systems (particularly overhead systems) for purposes such as painting of various types of articles. For example, it is not uncommon to paint products or articles through the use of electrostatic finishing stations. Still further, and as an example, in the powder painting industry, articles may be supported on hangers and carried along by a conveyor through finishing stations. This may include the steps of cleaning, rinsing, drying, coating and baking. It is not uncommon for finishing to include traveling through an electrostatic spray booth where the articles, electrostatically grounded through hangers to the conveyor, are coated with an electrically charged paint particulate. After the articles have been coated with a paint particulate, the hangers are transported to an oven where the paint is baked onto each article.

Each painting and baking operation, in addition to applying paint to the articles, may apply a coating to the exposed portions of the hanger as well as the hooks, except for a small area where the hooks contact the articles. Unless similar articles are painted in subsequent operations, where each article is in electrical contact with the hook in the same location, it is sometimes necessary to provide a clean support hook for each subsequent operation. In addition, because the hanger is coated each time it travels through the finishing process, the electrical contact between the hooks arid the hangers can become covered and damaged, thus requiring the hanger to be cleaned before using it in another coating process.

When the hooks and hangers become coated with a baked paint, the coating cannot be merely washed away or cleaned. Instead, it needs to be burned off or chipped away. In known systems, during the baking process, articles are subjected to relatively high temperatures. However, also in known systems, to burn the paint off, the hangers and hooks must be subjected to extremely high temperatures. These obviously consume a large amount of energy.

In regard to prior art, Reas, U.S. Pat. No. 5,233,795 issued Aug. 10, 1993 discloses a paint line cleaning system having an elongated enclosure or housing. The enclosure has an inlet and an outlet. A nozzle is supported within the housing, and connected to a source of cleaning material. The nozzle is positioned by a programmable robot. A pair of door sets mounted on the enclosure open and close the inlet and outlet. A portion of the paint line system to be cleaned may pass into the enclosure and the nozzle is positioned so that the cleaning media removes paint and the like.

In an attempt to overcome problems with manual cleaning of components of paint line systems, it is known that at least one in-line cleaning system has been developed. The system is disclosed in Guttman, et al., U.S. Pat. No. 3,830,196 issued Aug. 20, 1974. This system includes an oven positionable along the paint line system. The oven utilizes a plurality of gas burners which remove the paint from the paint hangers, by burning the paint to ash. The paint hangers are subsequently washed so as to remove the ash.

Yates, et al., U.S. Pat. No. 5,908,120 issued Jun. 1, 1999 discloses a specific configuration for a hanger to be utilized when supporting articles to be electrostatically painted. The hangers are utilized in an electrically grounded system for supporting a series of articles to be electrostatically coated with a paint particulate. The hanger system is supported from a grounded conveyor system and includes a support descending from the conveyor system. Several slide bars are carried by the support. A series of hooks having a shoulder and an arm are slidably positioned within the slide bar, with the arms extending through a slot within the slide bar. The shoulder of the hook or hanger engages the interior surface of the slide bar in at least two contact points, and the arm carries the articles to be painted. The slot extends the length of the slide bar, such that the hooks are universally placeable along the length of the slide bar. By having the shoulder positioned within the interior of the slide bar, paint particulate does not accumulate or adhere to the contact points between the slide bar and the shoulder. The support and slide bars may thus be utilized in a number of subsequent painting operations, allegedly without having to be cleaned, by replacing the painted hooks.

A general overhead conveyor cleaning apparatus is disclosed in Bowman, Jr., U.S. Pat. No. 4,678,075 issued Jul. 7, 1987. Bowman, Jr. discloses a cleaning apparatus for continuous cleaning of an overhead conveyor system. The apparatus includes one or more exterior mounted wire brush assemblies arranged on the guide rail of the conveyor system, for operative cleaning engagement with the conveyor. A threaded adjustment is provided so that the pressure exerted on the conveyor by the cleaning brushes can be selectively varied. For conveyors comprising an enclosed, box-section guide rail, the apparatus is configured so as to include a tension-carrying internal brush assembly integrated into the conveyor itself. In this form, cleaning engagement is effected between the exterior brushes and the tension-carrying internal brush, whereby the internal brush is periodically cleaned.

Each of the foregoing patent references describes a paint conveyor system in substantial detail. A summary of some known processes for stripping of paint hangers is illustrated in the prior art views of FIGS. 1 and 2, and described in the following paragraphs. It should be emphasized that the apparatus and methods associated therefor as illustrated in FIGS. 1 and 2 represent an “offline” stripping process.

Turning to FIGS. 1 and 2, FIG. 1 illustrates, in schematic and diagrammatic format, an overhead paint conveyor system 100. The paint conveyor system 100 may be a conventional overhead conveyor system, which utilizes paint hangers to removably hold articles to be painted to the overhead, conventional lines of the conveyor system 100. The conveyor system 100 includes a series of conveyor “lines” 102. The lines 102 are well known in the industry, and would be utilized to support an article 106 through a paint hanger 104. The paint hanger 104 would, correspondingly, be supported by the conveyor line 102. As earlier stated, the painting means may be by electrostatic painting, and it is therefore important that the hanger 104 provide for a conductive and grounded connection to the conveyor line 102. The conveyor line 102 would then be typically grounded in a conventional fashion. The various processes to be undertaken during the entirety of a painting process are undertaken through the use of apparatus which are typically referred to as “stages.” The stages are shown in FIG. 1 as stages 1-11. Each stage represents a known apparatus and process associated with painting of articles 106, where the articles 106 are suspended to conveyor lines 102 through the use of paint hangers 104. Also, it should be noted that the process utilized for painting articles 106 through the use of the paint conveyor system 100 is typically referred to as a “continuous process” paint conveyor system.

With reference specifically to FIG: 1, Stage 1 represents a location where the articles 106 to be painted are placed on the paint hangers 104. This placement is typically performed as a manual process. Following this activity, the articles 106 are transported to Stage 2 through the conveyor lines 102. Stage 2 represents a wash cycle, where the articles 106 to be painted are placed within a conventional wash solution, so as to prepare the articles 106 for the painting process. Following the wash cycle Stage 2, the articles 106 are transported to Stage 3, which represents a plating cycle. The plating cycle 3 may be a conventional electrostatic plating, where material is plated onto the article 106 through an electrostatic process. Also, other types of plating or related processes may be utilized, without departing from novel concepts of the invention. Following the plating cycle 3, the articles 106 may be transported through conveyor lines 102 to a powder coating cycle represented as Stage 4. Stage 4 may involve the application of various types of powder coating materials to the plate materials on the articles 106. The powder coating cycle of Stage 4 may include a bake oven to cure the powder coating. It is also within the scope of the invention to include coating processes other than powder coating. For example, the articles 106 may be warmed up and transported a fluidized bed. Particulate will then adhere to the articles 106, and the articles 106 can again be cured. Following Stage 4, the articles 106 may be transported to a touch up Stage 5. The touch up Stage 5 would typically be somewhat manually controlled, with either manual or automated means for viewing the article to determine if any touch ups are required or, alternatively, if the article 106 should be discarded in view of the painting process being defective for that particular article 106.

Following touch up Stage 5, the articles 106 would be transported to the Stage 6. At this stage, the articles 106 would be removed from the hangers 104 and conveyor lines 102. The articles 106 would then be placed in packaging for purposes of shipment.

Following Stage 6, the hangers 104 are then empty as they move along the conveyor lines 102. At Stage 7, the paint hangers 104 themselves are examined. Such examination is typically manual, but could, theoretically, be automated. If it appears that a particular hanger 104 is in a state such that paint or other materials on the hanger may interfere with the painting process or the conductive grounding of the articles 106 through the hangers 104, the particular hanger 104 would then be removed from the conveyor line 102. The paint hanger 104 at issue would then be manually placed in a basket and transported to a stripping area. The stripping area would typically be separate and apart from the paint conveyor system 100 and the conveyor lines 102.

FIG. 2 illustrates a prior art offline stripping system 108 in diagrammatic form. As earlier stated, at Stage 7, the paint hangers 104 would be examined. If stripping is required of paint or other materials, the hangers 104 are removed and transferred to the offline stripping system 108. As the paint hangers 104 are manually transferred to the stripping system 108, they are placed in baskets 110 illustrated in diagrammatic format in FIG. 2. The baskets 110 are conventional in nature and could be placed so as to hang from stripping system lines 112 existing between the various stages of the stripping system 108. After the hangers 104 are placed in baskets 110 at the stripping system Stage 8, they are transported through stripping system lines 112 (either manually or by a conveyor system) to a heated chemical tank at Stage 9. The chemicals are conventional in nature and utilized as filters for purposes of removing undesired paint from the hangers 104. The chemical materials and the temperatures for use of the same are well known in the prior art. Also well known are the time periods during which the hangers 104 would remain in the heated chemical tank. Following the chemical treatment at Stage 9 for removal of the paint, the baskets 110 would then be transported (again, either manually or through stripping system lines 112) to a rinse Stage 10. The rinse Stage 10 would include certain liquids adapted for use in manually removing and carrying out paint residue and chemicals remaining from the chemical process occurring during Stage 9. It is relatively common to utilize a wand-type pressure washer or a similar washing mechanism at Stage 10 for removal of the residue. Still further, Stage 10 can also include a burnoff oven, again well known in the prior art. The burnoff oven can utilize relatively high temperatures for purposes of further removal of residue. Following this burnoff process at Stage 10, the paint hangers 104 can then be manually removed from the baskets 110 and reinstalled on the continuous paint conveyor system 100 at Stage 11 of the system 100. The cleaned paint hangers 104 can then move from Stage 11 towards Stage 1, where new articles 106 to be painted can be placed on the hangers 104.

The prior art paint conveyor system, described herein as paint conveyor system 100 and stripping system 108, may involve several disadvantages. For example, with the manual activities associated with the stripping system 108, labor costs may be extensive. Also, as a result of requiring the manual transfer process to and from the stripping system 100 and the baskets 110, damage to paint hangers may be facilitated. Such damage can result in poor conductivity, resulting in a poor grounding path for the articles 106 through the conveyor system 100. Also, with the use of the baskets 110, unstripped areas on the paint hangers 104 may result where the paint hangers 104 contact the middle of the baskets 110. Still further, while the stripping system 108 is cleaning paint hangers 104, additional hangers 104 would be required. Still further, with the requirement of the use of additional paint hangers 104, additional plant floor space may be required for purposes of storage.

Still further, additional material handling equipment may be required to move paint hangers 104 from the conveyor system 100 to the stripping system 108. It should be mentioned at this time that the stripping system 108 and conveyor system 100 may be characterized as a “batch” stripping system, in that the entire stripping process may be characterized as a batched process. This equipment can be relatively bulky and expensive, and repairs can be time consuming and labor intensive. Still further, the stripping system 108 in accordance with the prior art would typically not have the paint hangers 104 cleaned during every process cycle of the conveyor system 100. Accordingly, these typical batch processes would allow paint hangers 104 to cycle through the system 100 process more than once prior to stripping. These multiple process cycles without cleaning can result in what is often referred to as a “dead hanger.” In this regard, paint powder can remain which bridges from the paint hanger 104 to the article 106 being coated. This can present several problems. First, the article 106 to be coated will have a relatively poor appearance. Further, the electrostatic painting process may result in a relatively light coat of paint, due to the lack of proper grounding of the article 106 through the electrostatic paint process.

Still further, prior art processes, using a substantial amount of manual activities, often facilitate the risk of injury to workers performing the material movements and the more manually intensive batch stripping system process. Still further, the prior art systems result in powdered ash as a byproduct of the Stage 10 batch system burnoff operation. Still further, workers involved in the processes associated with the stripping system 108 will have relatively high exposure to strip chemicals, when performing manual dipping operations in known batch systems. Such exposure can involve substantial health and environmental risks.

### BRIEF DESCRIPTION OF THE DRAWINGS

An illustrative embodiment of the invention is described in the following detailed description, with reference to the drawing, in which:

FIG. 1 is a prior art block and diagrammatic diagram of a prior art paint conveyor system;

FIG. 2 is a block and diagrammatic illustration of a prior art paint hanger stripping system; and

FIG. 3 is a block and diagrammatic illustration of an in-line stripping apparatus in accordance with the invention.

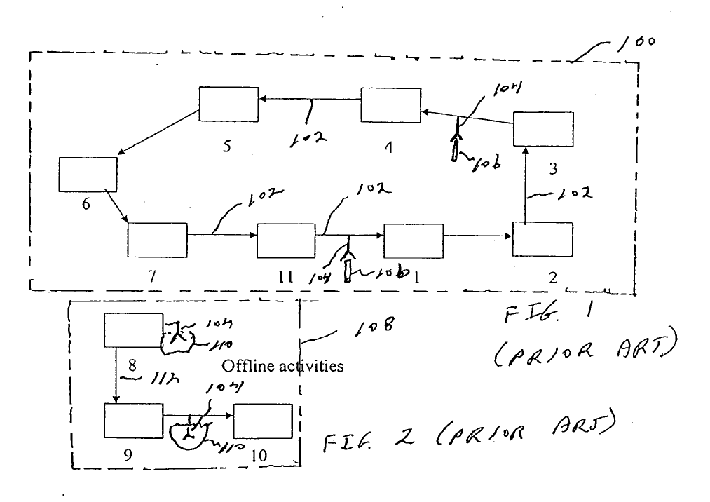

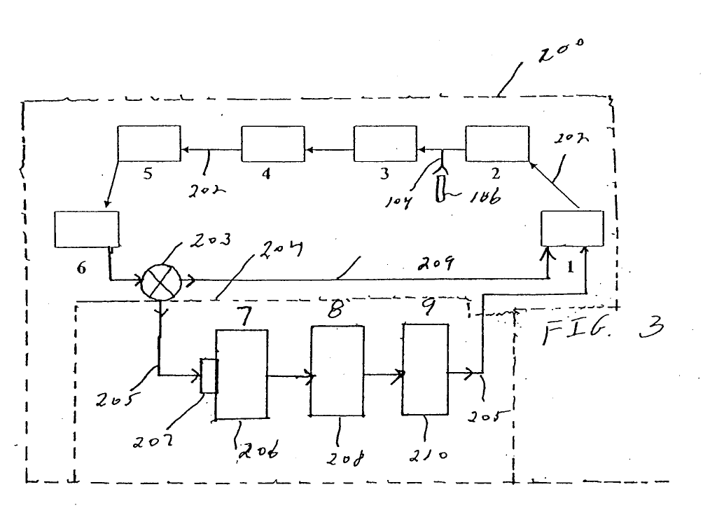

### DETAILED DESCRIPTION

The principles of the invention are disclosed, by way of example, in an in-line stripping system 204 as illustrated in FIG. 3. The in-line stripping system 204 is adapted for use in a paint conveyor system 200 having various stages similar to the conveyor system 100 previously described herein, and to conveyor systems associated with other prior art. However, the stripping system 204 in accordance with the invention is advantageous in that it reduces labor costs associated with the typical paint conveyor system and paint hanger cleaning systems. In addition, damage to paint hangers is relatively eliminated, at least that resulting from typical manual transfer processes to and from baskets. Still further, with the in-line process, there is an elimination of any need for additional hangers. As earlier explained, with the typical offline stripping system, additional hangers are required while other paint hangers are being cleaned.

Also relating to the additional hangers, with an in-line stripping system 204 in accordance with the invention, there is no need of additional plant floor space to store additional paint hangers. Still further, since the stripping system processes in-line, material handling equipment typically needed to move paint hangers in and out of the typical batch stripping system are no longer required. Still further, the in-line stripping system 204 in accordance with the invention improves the quality of the painted articles being produced, due to the fact that all paint hangers are cleaned during every process cycle. As previously described, typical offline batch processing systems allow paint hangers to cycle through more than once, resulting in “dead” hangers. The dead hangers cause paint powder bridging from the paint hangers to the article being coated, resulting in poor appearance and causing undesirable light coats of paint due to the lack of grounding of the painted article for the electrostatic paint process. Still further, the new process eliminates the risk of injury to workers typically performing material movements and manually intensive batch system processes. Also, the stripping system 204 in accordance with the invention eliminates powdered ash typically resulting from known batch system burnoff operations. Finally, health and environmental risks to workers are substantially reduced, since there is less exposure to stripping chemicals and manual dipping operations performed in the typical batch stripping systems are no longer required in the in-line stripping system 204 in accordance with the invention.

Turning to FIG. 3, and as earlier described, the in-line paint conveyor system 200 includes a number of stages similar to those included within the prior art system 100. More specifically at Stage 1, the articles 106 to be painted are manually placed on the paint hangers 104. The paint hangers 104 and articles 106 are then transferred on conveyor lines 202 to Stage 2, where the articles 106 are moved through a wash cycle. Following the wash cycle Stage 2, the articles 106 move on the paint hangers 104 to an electrostatic plating cycle Stage 3. Also, other types of plating or related processes may be utilized, without departing from novel concepts of the invention. After the electrostatic plating cycle is completed in Stage 3, the articles 106 move on the paint hangers 104 on conveyor lines 202, to a powder coating cycle Stage 4. At this stage, a powder coating is electrostatically applied to the articles 106 and run through a bake oven for purposes of curing the powder coating. It is also within the scope of the invention to include coating processes other than powder coating. For example, the articles 106 may be warmed up and transported a fluidized bed. Particulate will then adhere to the articles 106, and the articles 106 can again be cured. After Stage 4, the articles 106 are transferred to a touch up Stage 5. Touch up Stage 5 in the conveyor system 200 is similar to the touch up Stage 5 previously described with respect to system 100. That is, if the articles 106 require any type of painting or powder coating repair, such activities may occur at Stage 5.

After the Stage 5 touch up process is completed, if necessary, the articles 106 are moved to Stage 6. Following transport to Stage 6, the articles 106 can be removed from the paint hangers 104, with the articles 106 being placed in packaging for shipment. The hangers 104 are then empty as they move along the conveyor lines 202. Following Stage 6, the operator of the system 200 now has an option with respect to cleaning or stripping of the paint hangers 104. Specifically, the operator has an option to move the empty paint hangers 104 from Stage 6 to the in-line stripping system 204. Alternatively, if the operator wishes, the in-line stripping system 204 can be bypassed, and the empty paint hangers 104 moved directly from Stage 6 back to Stage 1 along a conveyor line identified in FIG. 3 as conveyor line 209. The capability of using the bypass conveyor line 209 allows the paint hangers 104 to be cleaned at less frequent intervals than each pass through the system 200. That is, if desired, the operator can cause the paint hangers 104 to move directly from Stage 6 to Stage 1, without transport through the in-line stripping system 204.

This optional capability is represented in FIG. 3 by a switch 203. The switch 203 can be any type of physical device usable by the operator of the system 200, which can cause the empty paint hangers 104 to be transported from Stage 6 directly to conveyor line 209 or, alternatively, transported from Stage 6 to conveyor line 205 and into the in-line stripping system 204. Also, the switch 203 can be motorized, electromechanical in nature, or can include various types of structure and components. Further, the paint hangers 104 may be manually switched onto line 205 or 209. Also, it should be emphasized that if it is desired to perform the stripping process on every pass, the switch 203 is unnecessary. Removal of the switch 203 does not depart from many of the principal concepts of the invention.

Assuming that the operator chooses to have the empty paint hangers 104 exiting from Stage 6 to be applied through the in-line stripping system 204, the paint hangers 104 will move along conveyor lines 205 and routed to a Stage 7, which comprises a stripping tank 206. However, prior to entry into the stripping tank 206, the paint hangers 104 are first applied to a pre-dip prestage 207. The pre-dip process occurring at prestage 207 comprises a dipping process. Each of the empty paint hangers 104 is dipped in a pre-dipped solution. One exemplary solution which may be utilized in accordance with the invention comprises 15% solvent based stripper, 20% potassium hydroxide and 65% water. Various brands of solvent based strippers may be utilized. One commercially available brand of solvent based stripper usable for the pre-dip solution is known in the industry as SEC 1148. It has also been found that it may be preferable for the pH level of the pre-dip solution to be approximately 13. Also, it has further been found that it is preferable for the dwell time for the hangers 104 to remain in the pre-dip solution to be in the range of approximately 30 seconds to approximately 5 minutes.

Following application of the paint hangers 104 to the pre-dip solution within the pre-dip prestage 207, the paint hangers 104 remain on the conveyor lines 205 and are routed to the primary section of Stage 7. The primary section of Stage 7 comprises a stripping tank 206. Therein, the paint hangers 104 are sprayed with a heated chemical solution. It has been found that one solution which is usable in accordance with the invention consists of 20% potassium hydroxide and 80% water. It has also been found that it is preferable for the spray solution to be heated. As an example, the solution may be heated through the use of gas through a burner tube. It has further been found that it may be preferable, in accordance with the invention, for the spray solution to be applied at a temperature in the range of 170° to 240° Fahrenheit.

Still further, after completion of the spraying of the heated chemical solution in Stage 7, runoff of the solution (or a percentage of the solution) can be preferably routed through a separator tank. Within this separator tank (also part of Stage 7), precipitation of solids will take place. The solution runoff will become stagnant, thereby allowing components to separate. Solids will fall to the bottom of the separator tank, and will then fall by gravity to a centrifuge. The centrifuge (a device commonly known in the industry) can be utilized to spin the solution. After this centrifugal process, solids within the solution (which will consist of stripped paint) may be automatically dumped from the centrifuge after given periods of time. These solid wastes can be gathered in a barrel or the like and disposed of in any suitable and “environmentally proper” manner. Liquid solution remaining after these processes can be made to flow back to a process tank, with the tank feeding the sprayer solution. As with the pre-dip solution, it has been found that it may be preferable for the pH level of the sprayer solution to be approximately 13.

After completion of processes associated with the Stage 7 stripping tank 206, the paint hangers 104 continue on the conveyor lines 205 toward Stage 8, which comprises an automatic rinse stage 208. Within the rinse stage, the paint hangers 104 are preferably automatically rinsed with appropriate liquid solutions, and paint residue and chemicals are carried off. It has been found that the automatic rinse solution may consist of 100% water. Also, it may be preferable for the temperature of the water to be in the range of approximately 50° to 80° Fahrenheit. Upon completion of Stage 8, comprising the automatic rinse stage 208, the paint hangers 204 are then transported on the conveyor lines 205 (where they have remained during the entirety of the in-line stripping process) to Stage 9, which comprises a dryer 210. Therein, the paint hangers 104 are appropriately dried. For purposes of performing the drying process, it has been found that either a forced air dryer or ambient air may be utilized. When the drying process is completed, the paint hangers 104, still remaining on the conveyor lines 202, are transported back to Stage 1, where articles 106 to be painted are placed on the cleaned paint hangers 104. With respect to the entirety of the process within the “loop system,” the total cycle time may be in the range of approximately 30 minutes.

In accordance with the foregoing, the stripping system 204 in accordance with the invention comprises a completely in-line process, and the paint hangers 104 to be cleaned do not have to be removed from the conveyor lines 202 or 205 of the paint conveyor system 200. Also, in accordance with certain aspects of the invention, the in-line stripping system 204 can be structured in the form of a “loop” off of a main line following Stage 6 of the system 200. This permits the operator to bypass the stripping process stages, if desired. In this manner, hangers can be cleaned at intervals less frequent than each pass through the system 200. That is, if the operator wishes to bypass the in-line stripping process at any given time, the system permits transport of the paint hangers directly from Stage 6 to initial Stage 1, without being transported through the cleaning stages. Still further, and as earlier stated, labor costs associated with typical prior art systems are relatively reduced. Potential damage to paint hangers 104 from manual transfer processes to and from baskets is eliminated. An increase exists in the percentage of clean hangers 104, since the prior art systems typically leave unstripped areas on paint hangers 104 which are located in the middle of baskets during the cleaning process. Also, as earlier mentioned, additional hangers are not required, eliminating their need and the need of additional plant floor space for storage of the same.

Still further, the requirements for material handling equipment are also eliminated, where the equipment is typically used to move paint hangers 104 in and out of the typical offline batch system. Also, with the paint hangers 104 being cleaned during every process cycle, improvement occurs with respect to the quality of the painted product. The probability of dead hangers is substantially reduced. Accordingly, the occurrence of paint powder bridging from the paint hangers 104 to the articles 106 is also reduced. This enhances the probability of appropriate appearance and reduces the probability of light paint coats due to improper grounding.

Also as previously mentioned, the in-line stripping process in accordance with the invention reduces the risk of injury to workers, since the performance of material movements and manually intensive batch system processes is reduced. Also, the need to handle powdered ash from manual batch system burnoff operations is eliminated. Still further, health and environmental risks to workers is reduced, since there is a reduced exposure to strip chemicals which may exist when performing typical manual dipping operations in the typical prior art batch systems.

It will be apparent to those skilled in the pertinent arts that other embodiments of in-line stripping systems in accordance with the invention may be designed. That is, the principles of an in-line stripping system in accordance with the invention are not limited to the specific embodiment described herein. Accordingly, it will be apparent to those skilled in the art that modifications and other variations of the above-described illustrative embodiment of the invention may be effected without departing from the spirit and scope of the novel concepts of the invention.

What is claimed is:

1. A method for stripping paint hangers in a paint conveyor system, said system comprising a plurality of operation stages for operating on articles releasably coupled to said paint hangers, and with said paint hangers releasably supported from at least one conveyor line during passing of said articles through said operation stages, said method comprising:
performance of operations on said articles at said operation stages, while said paint hangers are supported from said conveyor line;
removing said articles from said paint hangers following completion of performance of said operations on said articles;
performing in-line stripping processes on said paint hangers, while said paint hangers remain on said conveyor line, and in the absence of necessity of any removal of said paint hangers from said conveyor line at any time following performance of said operations on said articles; and
returning stripped paint hangers to an initial one of said operation stages following said stripping processes.

2. A method in accordance with claim 1, characterized in that said performance of said in-line stripping processes on said paint hangers comprises:
passing said paint hangers while on said conveyor line through a stripping tank, for removing paint materials from said paint hangers;
passing said paint hangers through a rinse stage, while said paint hangers remain on said conveyor line; and
moving said paint hangers through a dryer stage for drying said hangers, while said paint hangers remain on said conveyor line.
